(19) United States
(12) Patent Application Publication
(10) Pub. No.: US 2016/0351284 A1
(43) Pub. Date: Dec. 1, 2016

(54) ALUMINUM ELECTRICAL WIRE AND WIRE HARNESS

(71) Applicant: YAZAKI CORPORATION, Tokyo (JP)

(72) Inventor: Yuuki YAMAMOTO, Shizuoka (JP)

(73) Assignee: YAZAKI CORPORATION, Tokyo (JP)

(21) Appl. No.: 15/167,543

(22) Filed: May 27, 2016

(30) Foreign Application Priority Data
Jun. 1, 2015 (JP) 2015-111070

(51) Int. Cl. H01B 1/02; C22F 1/047; H01B 7/00; C22C 21/06

(52) U.S. Cl. CPC H01B 1/023; C22C 21/06; C22F 1/047; H01B 7/0045

(57) ABSTRACT

An aluminum electrical wire includes an aluminum wire. In the radial cross section of the aluminum wire vertical to the longitudinal cross section, the average grain size of metal micro structure of the aluminum wire at the center thereof is larger than that in the periphery thereof. The aluminum wire therefore has high mechanical strength and break elongation as well as resistances to high-cycle fatigue and high-temperature creep.

### CROSS REFERENCE TO RELATED APPLICATION

This application is based upon and claims the benefit of priority from Japanese Patent Application No. 2015-111070, filed on Jun. 1, 2015, the entire contents of which are incorporated herein by reference.

### BACKGROUND OF THE INVENTION

1. Field of the Invention

The present invention relates to an aluminum electrical wire and a wire harness and more specifically relates to an aluminum electrical wire and a wire harness with mechanical properties improved.

2. Description of the Related Art

Recent trends in reducing weight of vehicles are increasing demand for thinner aluminum electrical wires. Specifically, in recent years, aluminum electrical wires are increasingly laid in vehicles and occupy a higher proportion of each vehicle. Aluminum electrical wires are required to be thinner and more lightweight. Moreover, aluminum electrical wires are required to improve in reliability under in-vehicle environments.

Aluminum electrical wires typically used as thin electrical wires are mainly electrical purpose hard-drawn aluminum wire defined in JIS C3108. However, the flexibility of aluminum wire is significantly lower than that of copper wire. It is therefore difficult to apply aluminum wires to portions repeatedly bent, such as portions around door hinges of vehicles.

Accordingly, there have been various attempts to increase the flexibility by adding a metal element to aluminum. For example, Japanese Patent Document No. 4927366 discloses an aluminum conductor for vehicle wiring purposes which includes predetermined contents of Fe, Cu, and Mg, and includes aluminum and unavoidable impurities as a residue, and has a diameter of 0.07 to 1.50 mm. Japanese Patent Document No. 4330005 discloses an aluminum conductor for vehicle wire harnesses which is obtained by a predetermined process and includes predetermined contents of Fe, Zr, and Cu. The remainder includes aluminum and unavoidable impurities. The aluminum conductor has a diameter of 0.07 to 1.50 mm.

### BRIEF SUMMARY OF THE INVENTION

However, the electrical wires of Patent Literatures 1 and 2 have insufficient tensile strength. It is therefore difficult to apply Patent Literatures 1 and 2 to electrical wire sizes with a radial cross-sectional area smaller than 0.75 sq (mm²), such as 0.5 sq or 0.35 sq, for example.

The present invention is made in the light of the problem of the conventional techniques. An object of the present invention is to provide an aluminum electrical wire with mechanical properties and bending resistance improved and can be made thinner and a wire harness using the aluminum electrical wire.

An aluminum electrical wire according to a first aspect of the present invention includes an aluminum wire. In the radial cross section of the aluminum wire vertical to the longitudinal cross section thereof, the average grain size of metal micro structure of the aluminum wire at the center is larger than the average grain size of metal micro structure in the periphery.

An aluminum electrical wire according to a second aspect of the present invention is the aluminum electrical wire according to the first aspect, in which the aluminum wire includes a large grain domain and a small grain domain, and in the radial cross section of the aluminum wire vertical to the longitudinal cross section thereof, the large grain domain is located at the center while the small grain domain is located around the large grain domain. The average grain size of metal micro structure constituting the large grain domain is larger than the average grain size of metal micro structure constituting the small grain domain.

An aluminum electrical wire according to a third aspect of the present invention is the aluminum electrical wire according to the second aspect, in which in the radial cross section of the aluminum wire vertical to the longitudinal cross section thereof, the radial cross-sectional area (Aₛₘₐₗₗ) of the small grain domain with respect to the total (Aₜₒₜₐₗ) of the radial cross-sectional area (A_{large}) of the large grain domain and the radial cross-sectional area (Aₛₘₐₗₗ) of the small grain domain satisfies the following relationship:

0.10≦Aₛₘₐₗₗ/A_{large}≦0.99

An aluminum electrical wire according to a fourth aspect of the present invention is the aluminum electrical wire according to any one of the first aspect, in which crystal grains of the metal micro structure constituting the periphery of the aluminum wire have predominantly (111), (211), and (311) textures parallel to the radial cross section of the aluminum wire vertical to the longitudinal cross section thereof.

An aluminum electrical wire according to a fifth aspect of the present invention is the aluminum electrical wire according to the second aspect, in which crystal grains of the metal micro structure constituting the small grain domain have predominantly (111), (211), and (311) textures parallel to the radial cross section of the aluminum wire vertical to the longitudinal cross section thereof

A wire harness according to a sixth aspect of the present invention includes an aluminum electrical wire according to first aspect.

The aluminum electrical wire of the present invention includes the aluminum wire, in which the average grain size of the metal micro structure at the center is larger than that in the periphery and has high mechanical properties and bending resistance. Accordingly, the aluminum electrical wire is applicable to wire sizes with a cross-sectional area of less than 0.75 sq (mm²), such as 0.5 sq, 0.35 sq, or thinner sizes, for example.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee. Specifically, FIG. 7A is executed in color.

FIG. 1 is a schematic radial cross-sectional view illustrating an example of aluminum electrical wire according to an embodiment of the present invention.

FIG. 2 is a schematic radial cross-sectional view illustrating another example of the aluminum electrical wire according to the embodiment of the present invention.

FIG. 3 is a schematic cross-sectional view illustrating an example of a cable according to the embodiment of the present invention.

FIGS. 4A to 4C are SEM (scanning electron microscope) images obtained by observing radial cross sections of aluminum wires in Example 1 which are obtained after final heat treatment at 250, 300, and 350° C.

FIG. 5 is a diagram in Example 1, illustrating: SEM images of cross sections of aluminum wires obtained after final heat treatment at 300 and 350° C.; and the ratio of the cross-sectional area of a small grain domain to the radial cross-sectional area of each aluminum wire.

FIG. 6 is a diagram in Example 1, illustrating an SEM image of an aluminum wire obtained after a final heat treatment at 300° C. and the relationship between radial position and grain size of the metal micro structure.

FIG. 7A is a diagram in Example 1, illustrating the results of measuring by electron backscatter diffraction (EBSD), orientation of metal micro structures in radial cross sections of aluminum wires obtained after final heat treatment at 250, 300, and 400° C.

FIG. 7B is a diagram illustrating the correspondence between positions and crystal orientation in Example 1 in a stereographic triangle (an inverse pole figure).

FIGS. 8A to 8C are SEM images obtained by observing radial cross sections of aluminum wires which are obtained after final heat treatment at 200, 250, and 300° C. in Example 2.

FIG. 9 is a diagram in Example 2, illustrating an SEM image of a radial cross section of the aluminum wire obtained after a final heat treatment at 300° C. and the ratio of the radial cross-sectional area of the small grain domain to the radial cross-sectional area of the aluminum wire.

FIG. 10 is a diagram illustrating the relationship between the final heat treatment temperature and conductivity of the aluminum wires in Example 1.

FIGS. 11A to 11C are schematic diagrams for explaining a bending test method.

FIG. 12 is a graph illustrating the relationship between bending strain and the number of bending cycles of the aluminum wires in Example 1.

FIG. 13 is a graph illustrating the relationship between the final heat treatment temperature and tensile strength or 0.2% proof stress of the aluminum wires in Example 1.

FIG. 14 is a graph illustrating the relationship between the final heat treatment temperature and break elongation of the aluminum wires in Example 1.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

### (Aluminum Electrical Wire)

Generally, material strength and break elongation have a negative correlation. It is said that higher strength materials are more resistant to high-cycle fatigue while higher ductility materials are more resistant to low-cycle fatigue. It is basically difficult to simultaneously implement both high ductility and resistance to high-cycle fatigue. Moreover, aluminum and aluminum alloys are generally subject to high-temperature deformation (creep) pronouncedly at 100 to 200° C. In order to increase the strength of wires at room temperature, crystal grains of wire materials are often made finer. However, wire materials composed of fine crystal grains are disadvantageous in terms of creep.

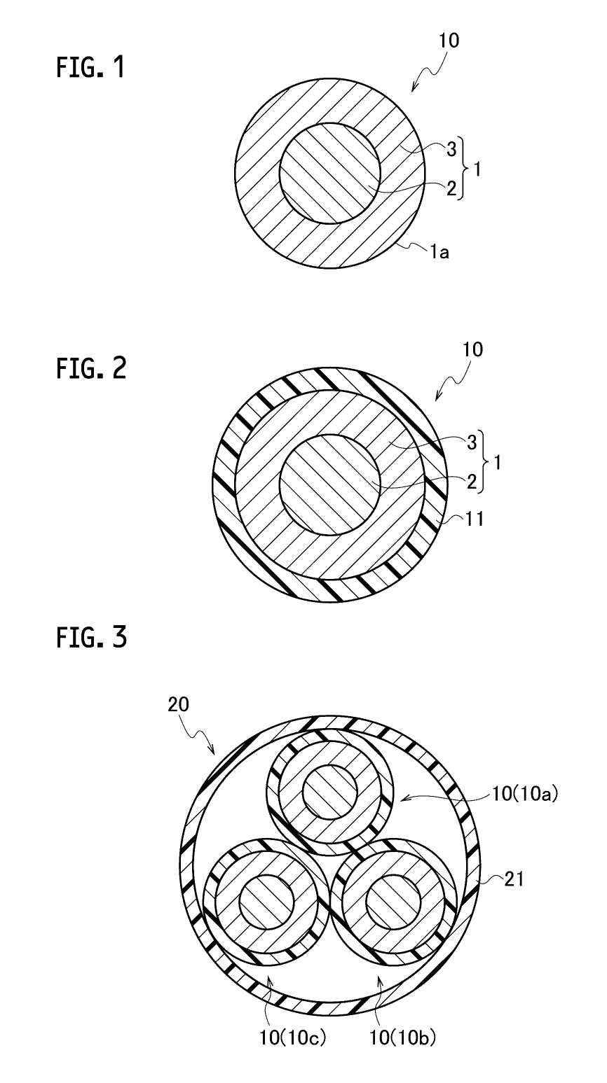

To improve the above-described material characteristics, an aluminum electrical wire 10 according to the embodiment includes an aluminum wire 1 as illustrated in FIG. 1. In the radial cross section of the aluminum wire 1 vertical to the longitudinal cross section thereof, the average grain size of the metal micro structure at the center is larger than that in the periphery.

Preferably, the aluminum wire 1 includes a large grain domain 2 and a small grain domain 3. In the radial cross section of the aluminum wire 1 vertical to the longitudinal cross section, the large grain domain 2 is located at the center thereof, and the small grain domain 3 is located around the large grain domain 2. The average grain size of the metal micro structure constituting the large grain domain 2 is larger than that of the metal micro structure constituting the small grain domain 3.

The aluminum wire 1 illustrated in FIG. 1 has a concentric structure in which the microstructure in the radial cross section thereof vertical to the longitudinal cross section is composed of the large grain domain 2 as an inner layer and the small grain domain 3 as an outer layer. To be specific, the large grain domain 2 is substantially circular at the center of the cross section. The small grain domain 3 is in contact with the large grain domain 2 and surrounds the entire circumference of the large grain domain 2 in the form of a torus.

The high-cycle fatigue is a fatigue phenomenon occurring when a metal material cyclically deforms in the elastic range. In the process of cyclic deformation of a metal material, slip bands formed inside extrude or intrude in the material surface to initiate fracture due to high-cycle fatigue. Accordingly, high-cycle fatigue can be made less likely to occur by reducing formation of slip bands.

High-cycle fatigue can also be made less likely to occur by reducing an increase in dislocations within metal materials. Generally, in a metal material composed of small crystal grains, dislocations are less likely to move under an external field (a stress field).

In the aluminum wire 1 of the embodiment, the small grain domain 3, in which the metal micro structure has a small average grain size, is formed as the outer layer. In the small grain domain 3, slip bands due to motion of dislocations, which can cause high-cycle fatigue, are less likely to occur as described above. The small grain domain 3 therefore contributes to the proof stress and resistance to high-cycle fatigue of the aluminum wire.

From the viewpoint of high-temperature fatigue characteristics of metal, the metal micro structure composed of small crystal grains is subject to grain boundary slip at high-temperature deformation and therefore has low resistance to creep. The crystal grains therefore require a certain size when metal materials are to be used in high-temperature and vibration environments and the like.

In the aluminum wire 1 of the embodiment, therefore, the large grain domain 2, in which the metal micro structure has a large average grain size, is formed as the inner layer. The large grain domain 2 contributes to the ductility and creep resistance of the aluminum wire 1. Accordingly, the large grain domain 2 can compensate low creep resistance attributable to the small grain domain 3.

As described above, in the aluminum wire 1 of the embodiment, the average crystal grain size of the metal micro structure at the center thereof is larger than that of the metal micro structure in the periphery. Moreover, the aluminum wire 1 includes the large grain domain 2 as the inner layer and the small grain domain 3 as the outer layer. The large grain domain 2 as the metal micro structure at the center increases the ductility and creep resistance of the aluminum wire 1 while the small grain domain 3 as the metal micro structure in the periphery increases the proof stress and high-cycle fatigue resistance of the aluminum wire 1. The aluminum wire 1 therefore has high mechanical strength and good break elongation as well as the resistances to high-cycle fatigue and high-temperature creep as a whole. The aluminum wire 1 also exerts high heat resistance and high resistance to bending and vibration.

The boundary between the large grain domain 2 and small grain domain 3 in the aluminum wire 1 is not clearly distinguished in some cases. In the embodiment, however, the aluminum wire 1 only needs to be configured so that the average grain size of the metal micro structure at the center of the aluminum wire 1 is larger than that of the metal micro structure in the periphery. When the metal micro structure of large grain size is located at the center of the aluminum wire 1 and the metal micro structure of small grain size is located in the periphery adjacent to a surface 1a of the aluminum wire 1, the metal micro structure at the center can increase the ductility and creep resistance while the metal micro structure in the periphery increases the proof stress and resistance to high-cycle fatigue.

Herein, the average grain size of the metal micro structure at the center of the aluminum wire 1 is not particularly limited but is preferably 2 to 50 μm and more preferably 2 to 10 μm, for example. The average grain size of the metal micro structure constituting the large grain domain 2 is also not particularly limited but is preferably 2 to 50 μm and more preferably 2 to 10 μm, for example. Setting the average grain sizes in the above range can further increase the resistance to low-cycle fatigue, heat resistance, and ductility of the aluminum wire 1.

The average grain size of the metal micro structure in the periphery of the aluminum wire 1 is not particularly limited but is preferably not more than 10 μm and more preferably 0.5 to 5 μm, for example. The average grain size of the metal micro structure constituting the small grain domain 3 is not particularly limited as long as being smaller than the average grain size of the metal micro structure constituting the large grain domain 2. For example, the average grain size of the metal micro structure constituting the small grain domain 3 is preferably not more than 10 μm and more preferably 0.5 to 5 μm. Setting the average grain sizes in the above ranges can further increase the resistance to high-cycle fatigue and vibration of the aluminum wire 1. The average grain size of the metal micro structure is calculated by weighted quadrature on an area ratio basis.

Many wire materials composed of metal or an alloy having a face-centered cubic lattice (fcc) structure tend to have (111), where atoms are packed densely, parallel to the radial cross section of each wire material because of compressive stress at the wire drawing process. The crystal grains with (111) parallel to the radial cross section, which are obtained by compressive stress in the wire drawing process, are fine in the radial cross section because of the compressive stress. However, such crystal grains are unstable in surface energy and are therefore unstable under external heat. Accordingly, an aluminum wire material including crystal grains with (111) texture parallel to the radial cross section can change in texture due to heat. To thermally stabilize fine crystal grains with (111) texture parallel to the radial cross section of the wire material, it is effective to disperse many mechanically strong particles (pinning particles) within the grains with (111) texture parallel to the radial cross section and grain boundaries thereof

As described above, (001) plane is thermally stable more than (111) plane. Accordingly, in the aluminum wire 1, it is preferable that the crystal grains of the metal micro structure constituting the large grain domain 2, which contributes to the resistance to high-temperature creep, have (001) texture parallel to the radial cross section. Moreover, it is preferable that the crystal grains of the metal micro structure constituting the periphery of the aluminum wire 1 and the small grain domain 3 have predominantly (111), (211), or (311) textures parallel to the radial cross section. Hereinafter, crystal grains with (001), (111), (211), or (311) textures parallel to the radial cross section are also referred to as (001), (111), (211), or (311) oriented grains, respectively. In other words, it is preferable that the aluminum wire 1 has a concentric structure including the large grain domain 2, in which crystal grains are predominantly (001) oriented, and the small grain domain 3, where crystal grains are predominantly (111), (211), or (311) oriented. The domain of (111), (211), and (311) oriented crystal grains contributes to increases in high-cycle fatigue resistance and proof stress of the aluminum wire 1 while the domain of (001) orientated crystal grains contributes to the creep resistance of the aluminum wire 1. By the above-described crystalline state, the aluminum wire 1 has high mechanical strength and good break elongation as well as the resistances to high-cycle fatigue and high-temperature creep as a whole.

Herein, preferably, in the radial cross section of the aluminum wire 1 vertical to the longitudinal cross section thereof, the radial cross-sectional area (Aₛₘₐₗₗ) of the small grain domain 3 with respect to the total (Aₜₒₜₐₗ) of the radial cross-sectional area (A_{large}) of the large grain domain 2 and radial cross-sectional area (Aₛₘₐₗₗ) of the small grain domain 3 satisfies the relationship expressed by Formula 1.

0.10≦Aₛₘₐₗₗ/Aₜₒₜₐₗ≦0.99 (1)

As described above, the large grain domain 2 contributes to increases in heat resistance and ductility because of the equiaxed grains of the drawn wire structure while the small grain domain 3 contributes to increases in resistances to high-cycle fatigue and vibration. Accordingly, controlling the ratio of the large grain domain 2 to the small grain domain 3 can balance the aforementioned conflicting characteristics successfully. By configuring the ratio of the cross-sectional area of the small grain domain 3 so as to satisfy the aforementioned relationship, the aluminum wire 1 can increase in high-cycle characteristics, ductility, and heat resistance.

More preferably, the radial cross-sectional area (Aₛₘₐₗₗ) of the small grain domain 3 with respect to the total (Aₜₒₜₐₗ) of the radial cross-sectional area (A_{large}) of the large grain domain 2 and radial cross-sectional area (Aₛₘₐₗₗ) of the small grain domain 3 satisfies the relationship expressed by Formula 2.

0.34≦Aₛₘₐₗₗ/Aₜₒₜₐₗ≦0.99 (2)

The composition of the metal micro structure of the aluminum wire 1 of the aluminum electrical wire 10 of the embodiment is not particularly limited as long as the aluminum wire 1 includes the large grain domain 2 and small grain domain 3. However, it is preferable that the aluminum alloy constituting the aluminum wire 1 is composed of an aluminum ingot as a matrix with a predetermined element added thereto.

The aluminum ingot is preferably pure aluminum with a purity of 99.7 mass % or more. Specifically, the aluminum ingot is preferably an aluminum ingot having not more than the impurity of class 1 among pure aluminum ingots written in JIS H2102 (Aluminum Ingots for Remelting). Concrete examples thereof are aluminum ingots of class 1 with an impurity of 99.7 mass %, aluminum ingots of special class 2 with an impurity of 99.85 mass % or more, and aluminum ingots of special class 1 with an impurity of 99.90 mass % or more.

The matrix composed of the aluminum ingot is preferably added with at least one element selected from a group consisting of titanium (Ti), iron (Fe), zirconium (Zr), copper (Cu), and silicon (Si). The inclusion of titanium miniaturizes crystal grains of the aluminum alloy and reduces the grain size distribution to increase the strength and elongation. By inclusion of titanium in the aluminum alloy, the workability for the aluminum alloy is thereby increased, and breaks of aluminum alloy wires at manufacturing is reduced. Iron, which has a low solid solubility limit, serves as a strengthening mechanism mainly strengthening grain boundaries. The inclusion of iron can therefore increase the strength of the aluminum wire 1 without lowering the electrical conductivity. Zirconium is effective on increasing the heat resistance and increases the strength of the aluminum wire 1 by grain boundary strengthening. The inclusion of copper can increase the strength by precipitation hardening. Silicon forms a solid solution with aluminum to increase the strength of the aluminum wire 1.

Unavoidable impurities that can be contained in the aluminum alloy used in the embodiment are zinc (Zn), nickel (Ni), tin (Sn), vanadium (V), gallium (Ga), boron (B), sodium (Na), and the like. These impurities are unavoidably contained in the aluminum alloy of the present invention to such a minor extent that the impurities cannot interfere with the effects of the present invention and does not particularly influence the characteristics of the aluminum alloy. The unavoidable impurities include elements already contained in the used pure aluminum ingot.

The aluminum electrical wire 10 of the embodiment may either include a single wire composed of the single aluminum wire 1 as a conductor or include a strand composed of a plurality of the aluminum wires 1 twisted. The strand may be any one of: a concentric strand which includes aluminum wires concentrically laid around one or several aluminum wires; a bunch strand including plural aluminum wires twisted together in the same direction; or a composite strand which includes plural bunch strands concentrically laid around one or several bunch strands.

The aluminum electrical wire 10 according to the embodiment may be a bare wire including the aluminum wire 1 as illustrated in FIG. 1. As illustrated in FIG. 2, the aluminum electrical wire 10 of the embodiment may include the aluminum wire 1 and an insulator layer 11 as a coating material covering the circumference of the aluminum wire 1.

The material and thickness of the insulator layer 11 covering the circumference of the aluminum electrical wire 10 are not particularly limited as long as the insulator layer 11 ensures electrical insulation from the aluminum electrical wire 10. Examples of the resin material constituting the insulator layer 11 are: vinyl chloride, heat-resistant vinyl chloride, cross-linked vinyl chloride, polyethylene, cross-linked polyethylene, polyethylene foam, cross-linked polyethylene foam, polyethylene chloride, polypropylene, polyamide (nylon), polyvinylidene difluoride, ethylene-tetrafluoroethylene copolymer, tetrafluoroethylene-hexafluoropropylene copolymer, tetrafluoroethylene, perfluoroalkoxy alkane, natural rubber, chloroprene rubber, butyl rubber, ethylene propylene rubber, chlorosulfonate polyethylene rubber, and silicone rubber. The insulator layer 11 may be composed of either one or a combination of two or more of the aforementioned substances.

Preferably, the aluminum wire 1 of the aluminum electrical wire 10 of the embodiment has a tensile strength of 230 MPa or more, a 0.2-proof stress of 150 MPa or more, a conductivity of 30% IACS or more, and an elongation percentage of 7% or more. The aluminum wire having such values of the tensile strength, 0.2-proof stress, and elongation percentage increases in the mechanical strength and is less likely to break during or after installation to the vehicle body. Accordingly, the aluminum electrical wire 10 of the embodiment is applicable to portions repeatedly bent, such as portions around door hinges of vehicles, and vibrating portions, such as an engine compartment. Moreover, the aluminum electrical wire 10 of the embodiment has a conductivity of 30% IACS or more and is therefore applicable as electrical wire for vehicles. The tensile strength, 0.2-proof stress, and elongation percentage (break elongation) are measured according to JIS Z2241 (Metallic Materials Tensile Testing). The conductivity is measured according to JIS H0505 (Measuring Methods for Electrical Resistivity and Conductivity of Non-ferrous Materials).

The final diameter of the aluminum wire 1 of the aluminum electrical wire 10 of the embodiment is not particularly limited. The aluminum wire according to the embodiment has high mechanical properties including tensile strength and elongation percentage and can be made thin. The final diameter can be set to 0.1 to 1.0 mm, for example.

The aluminum electrical wire 10 of the embodiment includes the aluminum wire 1. In the radial cross section of the aluminum wire 1 vertical to the longitudinal cross section thereof, the average grain size of the metal micro structure at the center thereof is larger than that in the periphery. The mechanical properties of the thus-configured aluminum electrical wire 10 are such that the tensile strength is not less than 230 MPa and the elongation percentage is not less than 7%. The aluminum electrical wire 10 is therefore applicable to wire with a radial cross-sectional area of less than 0.75 sq (mm²). The aluminum electrical wire of the embodiment is applicable to 0.5 sq, 0.35 sq, or thinner sizes, for example. The aluminum electrical wire 10 of the embodiment has resistance to high-cycle fatigue, ductility, and resistance to high-temperature creep and is therefore suitably applicable to high-temperature vibrating portions in vehicles.

### (Manufacturing Method of Aluminum Wire)

A description is given of a method of manufacturing an aluminum wire 1 used in the aluminum electrical wire 10 according to the embodiment. First, aluminum alloy is casted to produce a wire rod with a predetermined diameter by continuous casting and rolling or the like. The diameter of the wire rod is not particularly limited and can be any diameter such as 03 or 08 mm, for example. The aluminum alloy can be casted in accordance with a typical process by adding a predetermined element to an aluminum ingot.

Next, the wire rod is subjected to a thinning process. Specifically, the wire rod is drawn using a dice to produce an aluminum wire. The diameter of the aluminum wire can be properly adjusted in a range from 00.1 to 01.0 mm, for example. The conditions of the thinning process are determined depending on the strength of the aluminum alloy, the degree of work hardening, the shape of the dice, and lubricity of drawing oil.

The aluminum wire subjected to the thinning process is subjected to a final heat treatment. By controlling the temperature and time of the final heat treatment, the ratio of the large grain domain 2 to the small grain domain 3 can be changed. The conditions of the final heat treatment need to be adjusted depending on the desired ratio of the large grain domain 2 to the small grain domain 3, aluminum wire diameter, and aluminum wire metal composition. However, the final heat treatment is preferably performed at 260 to 340° C. for an hour or more. By performing the final heat treatment as described above, the obtained aluminum wire has a large grain domain at the center and a small grain domain in the periphery.

To increase the workability at the thinning process, the wire rod may be subjected to annealing before the thinning process. The annealing can be performed using a continuous annealing furnace. For example, the wire rod is conveyed at a predetermined speed through a heating furnace to be heated in a predetermined section for annealing. The heating means is a high-frequency heating furnace, for example. The annealing can be suitably batch annealing. The conveyance speed, annealing temperature and time, and the like are not particularly limited, and the conditions of cooing after annealing are also not particularly limited. The annealing temperature is preferably 260 to 340° C., and the annealing time is preferably 1 to 10 hours.

### (Cable)

Next, a description is given of a cable according to the embodiment. As illustrated in FIG. 3, a cable 20 according to the embodiment includes: a plurality of the aluminum electrical wires 10 (10a, 10b, and 10c) bundled; and a sheath 21 as a coating material enclosing the plural aluminum electrical wires 10 bundled. The material of the sheath 21 is not particularly limited and can be a similar substance to the material of the aforementioned insulator layer 11. The aluminum electrical wire 10 and cable 20 are preferably used in wire harnesses for vehicles which need high strength, high durability, and high conductivity.

Hereinafter, the present invention is described in more detail using examples. The present invention is not limited to the examples.

### Preparation of Aluminum Strand

### Example 1

High-purity aluminum (4N) is melted and is added with predetermined amounts of magnesium, manganese, and chrome for casting, producing aluminum alloys which contain 2.6 mass % magnesium, 0.28 mass % manganese, and 0.096 mass % chrome and have a diameter of 25 mm and a length of 20 cm.

Next, each aluminum alloy is rolled into a wire rod with a diameter of 8 mm. The obtained wire rod is annealed at 350° C. for one hour. The wire rod is then thinned using a dice into a aluminum wire with a diameter of 0.32 mm.

The obtained aluminum wires are subjected to the final heat treatment at 150, 200, 250, 300, 350, and 400° C. for one hour into six types of aluminum wires as test pieces.

### Example 2

High-purity aluminum (4N) is melted and is added with predetermined amounts of magnesium and manganese for casting, producing aluminum alloys which contain 2.5 mass % magnesium and 0.41 mass % manganese and have a diameter of 25 mm and a length of 20 cm.

Next, each aluminum alloy is rolled into a wire rod with a diameter of 8 mm. The obtained wire rod is annealed at 350° C. for one hour. The wire rod is then thinned using a dice into an aluminum wire with a diameter of 0.32 mm.

The obtained aluminum wires are subjected to the final heat treatment at 200, 250, and 300° C. for one hour into three types of aluminum wires as test pieces.

### (Evaluation)

### (Observation of Radial Cross Section)

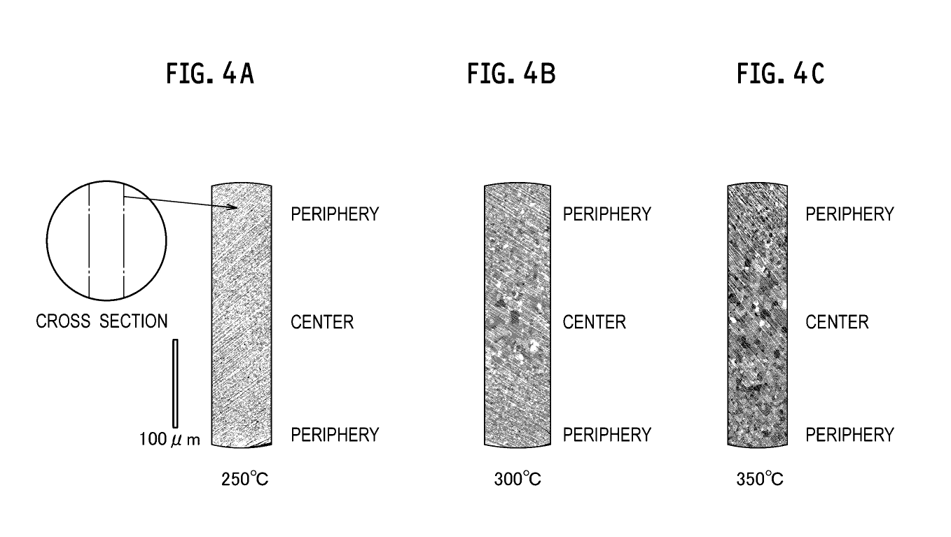

The radial cross sections of the test pieces obtained after final heat treatment at 250, 300, and 350° C. in Example 1 are observed with a scanning electron microscope (SEM). The results thereof are illustrated in FIGS. 4A to 4C, FIG. 5, and FIG. 6. When the final heat treatment temperature is 250° C., as illustrated in FIG. 4A, the crystal grains are small in the entire cross section of the test piece, and no large grain domain is formed. On the other hand, when the final heat treatment temperature is 300° C., as illustrated in FIG. 4B, grain growth initiates from the center of the cross section, and the average grain size at the center is larger than the average grain size in the periphery. Moreover, it is revealed that the large grain domain 2 is formed at the center and the small grain domain 3 is formed in the periphery. FIG. 4C shows that, when the final heat treatment temperature is 350° C., grains grow increasingly at the center and the area of the large grain domain 2 is increased.

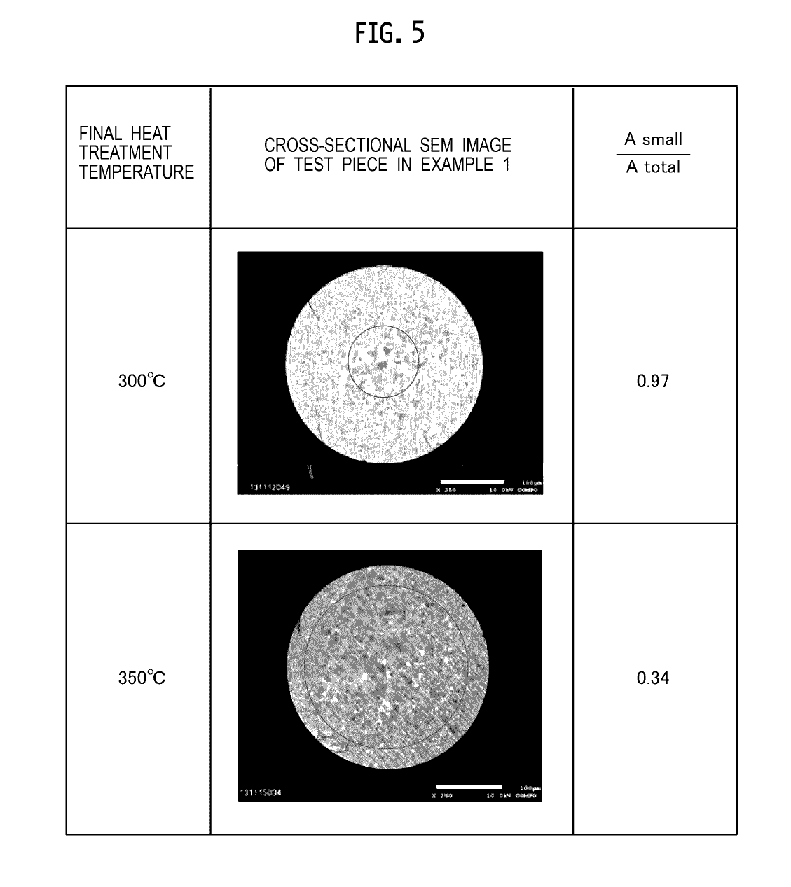

FIG. 5 illustrates radial cross-sectional SEM images of the test pieces obtained after the final heat treatment at 300 and 350° C. and the ratio of the radial cross-sectional area (Aₛₘₐₗₗ) of the small grain domain to the total (Aₜₒₜₐₗ) of the radial cross-sectional area (A_{large}) of the large grain domain and the radial cross-sectional area (Aₛₘₐₗₗ) of the small grain domain. As illustrated in FIG. 5, in these test pieces, the large grain domain at the center and the small grain domain in the periphery are formed concentrically. As the final heat treatment temperature increases, grains grow at the center more increasingly, thus reducing the ratio of the small grain domain. Moreover, it is revealed that the ratio of the large to the small grain domain is controlled by the at the final heat treatment.

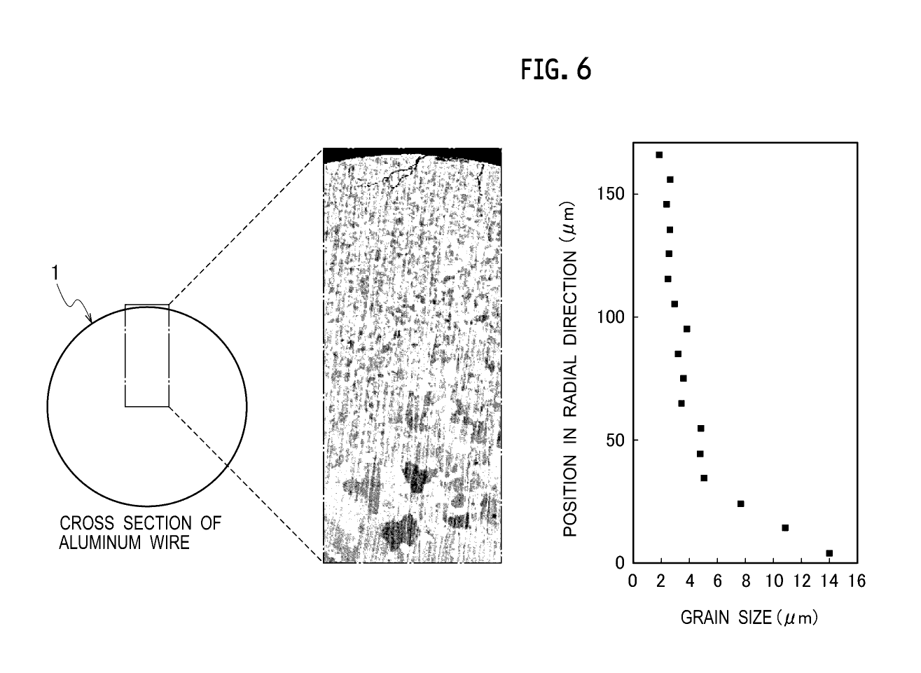

FIG. 6 illustrates a radial cross-sectional SEM image of a test piece obtained after a final heat treatment at 300° C. and the relationship between radial position and grain size of the metal micro structure. In the graph of FIG. 6, the position in the radial direction is defined with the center of the aluminum wire set to 0 As illustrated in FIG. 6, the grain size of the metal micro structure of the large grain domain is about 7 to 14 μm and is particularly maximized at the center of the large grain domain. The grain size of the metal micro structure of the small grain domain is about 2 to 5 FIG. 6 shows that the grain size of the metal micro structure decreases with distance from the center of the test piece toward the outer periphery.

### (Measurement of Orientation of Metal Micro Structure)

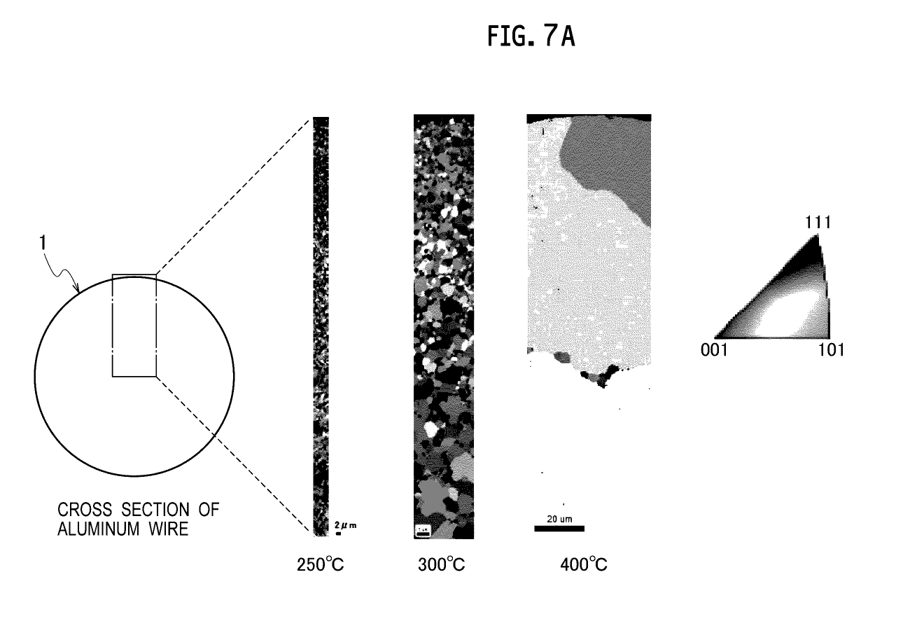

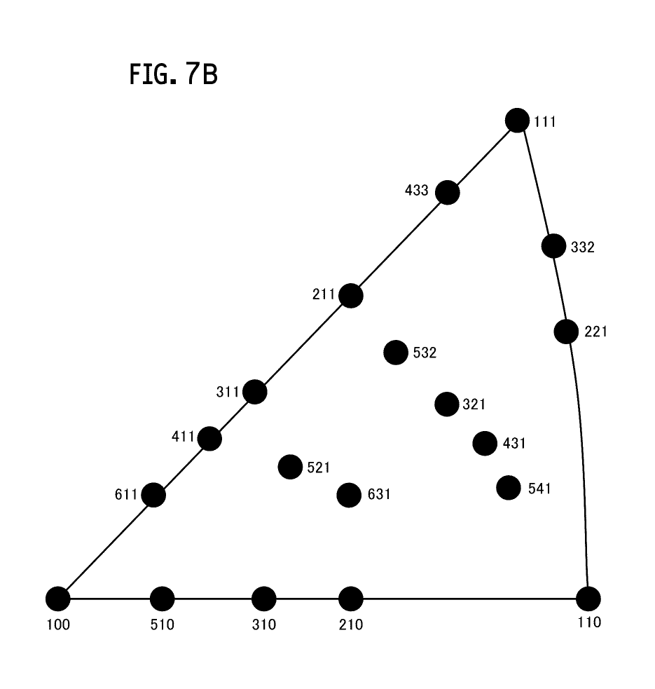

The radial cross sections of test pieces obtained after final heat treatment at 250, 300, and 400° C. are measured in terms of the orientation of the metal micro structure using electron backscatter diffraction (EBSD). The results thereof are illustrated in FIG. 7A. As illustrated in FIGS. 7A and 7B, in the test piece obtained after a final heat treatment at 250° C., grains are predominantly (111) oriented as a whole. The test piece obtained after a final heat treatment at 400° C. is not oriented as a whole.

As for the test piece obtained after a final heat treatment at 300° C., (111) oriented, (211) oriented, or (311) oriented crystal grains are maintained in the small grain domain in the periphery while (001) oriented grains are increased and become dominant in the large grain domain at the center. The crystal grains of the metal micro structure in the large grain domain are predominantly (001) oriented than those in the small grain domain. The crystal grains of the metal micro structure in the small grain domain are more (111) oriented, (211) oriented, and (311) oriented than those in the large grain domain. In terms of the thermal stability of crystalline planes in the fcc structure, (111) oriented grains are stable in the low-temperature range while (001) oriented grains are stable in the high-temperature range.

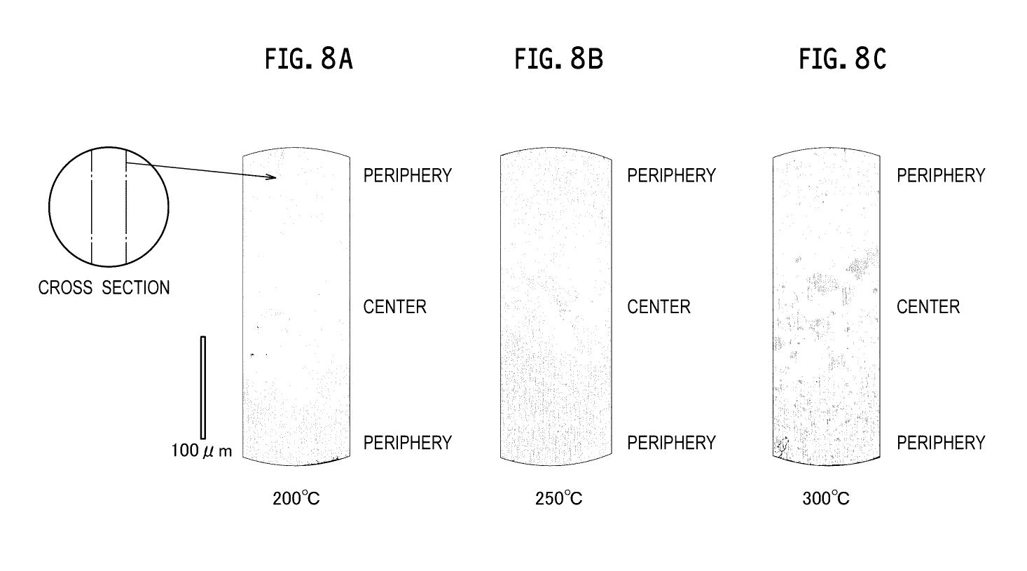

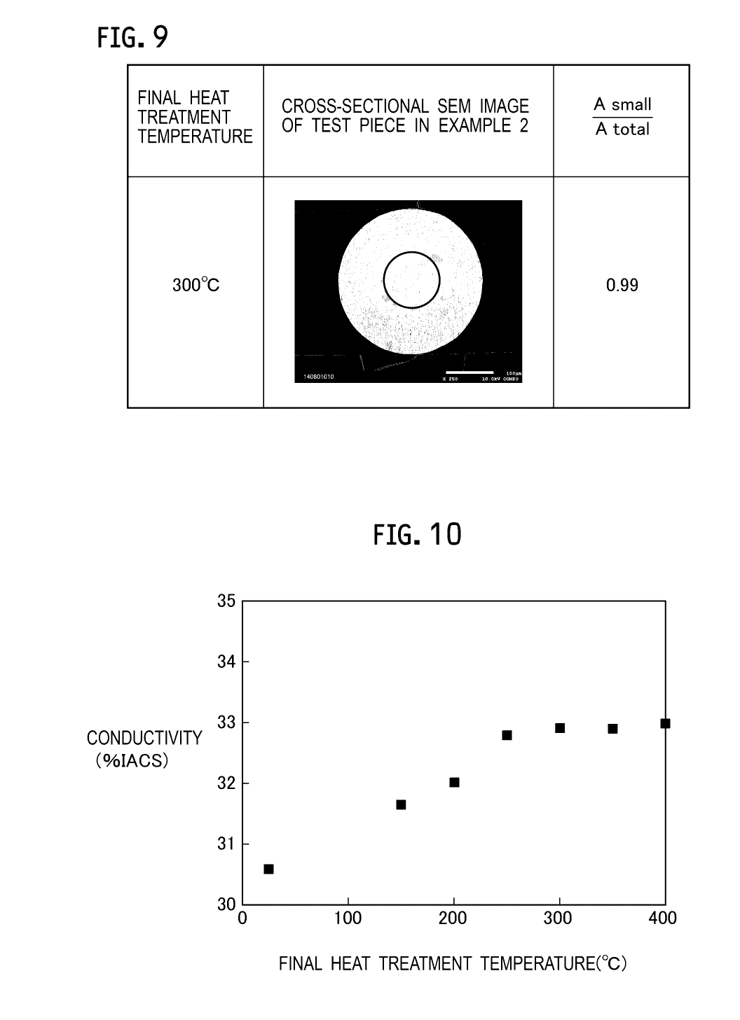

The radial cross sections of the test pieces obtained after final heat treatment at 200, 250, and 300° C. in Example 2 are observed with an SEM. The results thereof are illustrated in FIGS. 8A to 8C and FIG. 9. When the final heat treatment temperature is 200 and 250° C., as illustrated in FIGS. 8A and 8B, the crystal grains are small in the entire radial cross section of each test piece, and no large grain domain is formed. When the final heat treatment temperature is 300° C., as illustrated in FIG. 8C, grain growth initiates from the center of the radial cross section, and the large grain domain 2 is formed at the center while the small grain domain 3 is formed in the periphery.

FIG. 9 illustrates a cross-sectional SEM image of a test piece obtained after the final heat treatment at 300° C. and the ratio of the radial cross-sectional area (Aₛₘₐₗₗ) of the small grain domain to the total (Aₜₒₜₐₗ) of the radial cross-sectional area (A_{large}) of the large grain domain and the radial cross-sectional area (Aₛₘₐₗₗ) of the small grain domain. As illustrated in FIG. 9, it is confirmed that the large grain domain at the center and the small grain domain in the periphery are formed concentrically in this test piece in a similar manner to Example 1.

### (Conductivity Measurement)

The conductivity of test pieces obtained after final heat treatment at 150, 200, 250, 300, 350, and 400° C. in Example 1 is measured according to JIS J0505. The measurement results are illustrated in FIG. 10 and Table 1. The conductivity of aluminum wires not subjected to the final heat treatment in Example 1 is measured in a similar manner, and the results thereof are illustrated in FIG. 10 and Table 1. As illustrated in FIG. 10, all the test pieces have a conductivity of not less than 30% IACS, and it is revealed that the conductivity increases as the final heat treatment temperature increases. The test pieces obtained after final heat treatment at 250° C. or higher have conductivities of 32.50% IACS or higher.

TABLE 1

| Final Heat | | | | |
|---|---|---|---|---|
| Treatment | | Tensile | 0.2% Proof | Break |
| Temperature | Conductivity | Strength | Stress | Elongation |
| (° C.) | (% IACS) | (MPa) | (MPa) | (%) |
| No Heat | 30.6 | 509.4 | 475.0 | 1.1 |
| Treatment | | | | |
| 150 | 31.7 | 462.2 | 449.4 | 0.8 |
| 200 | 32.0 | 391.2 | 385.2 | 0.6 |
| 250 | 32.8 | 268.1 | 237.2 | 9.1 |
| 300 | 32.9 | 255.8 | 197.8 | 14.0 |
| 350 | 32.9 | 251.4 | 176.4 | 14.8 |
| 400 | 33.0 | 149.9 | 77.3 | 10.1 |

The conductivity of test pieces obtained after a final heat treatment at 300° C. in Example 2 is measured according to JIS J0505. The measurement results are illustrated in Table 2. It is also revealed that the test pieces obtained after a final heat treatment at 300° C. in Example 2 have a conductivity of not less than 32.5% IACS.

TABLE 2

| Final Heat | | | | |
|---|---|---|---|---|
| Treatment | | Tensile | 0.2% Proof | Break |
| Temperature | Conductivity | Strength | Stress | Elongation |
| (° C.) | (% IACS) | (MPa) | (MPa) | (%) |
| 300 | 33.9 | 255.8 | 168.2 | 10.7 |

### (Bending Test)

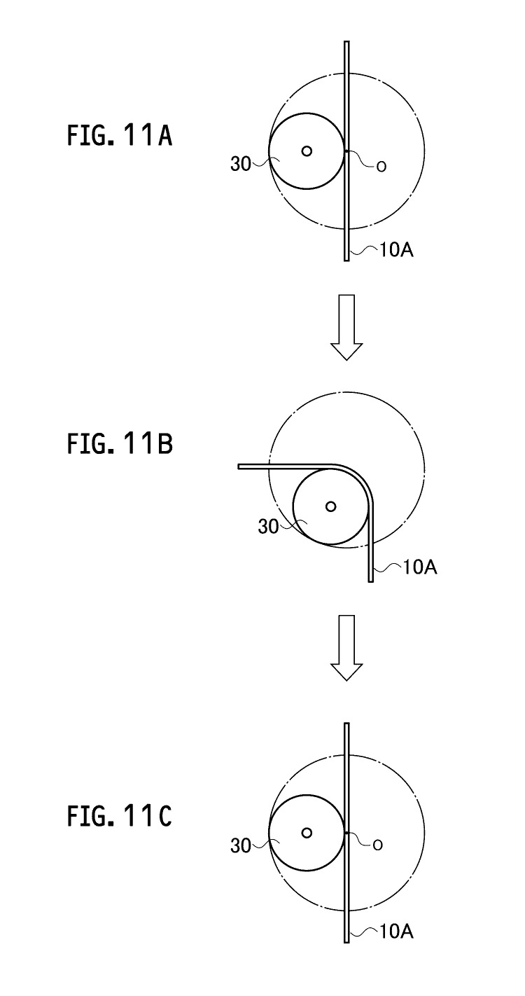

The test pieces of Examples 1 and 2 are subjected to the bending test illustrated in FIGS. 11A to 11C for measurement of the relationship between bending strain of each test piece and the number of bending cycles when the test piece is bent. Specifically, first, a linear test piece 10A is placed on one side of a bending R jig 30 as illustrated in FIG. 11A. Secondly, the bending R jig 30 is rotated around symbol O as the test piece 10A is bent by 90 degrees to one side as illustrated in FIG. 11B. The bending R jig 30 is then rotated around the symbol O to the original position as the test piece 10A is returned to the linear position. The test piece 10A is repeatedly subjected to the cycle illustrated in FIGS. 11A to 11C, and the number of cycles until the test piece 10A is broken is measured. The bending strain of each test piece that is bent can be controlled by changing the diameter of the bending R jig 30.

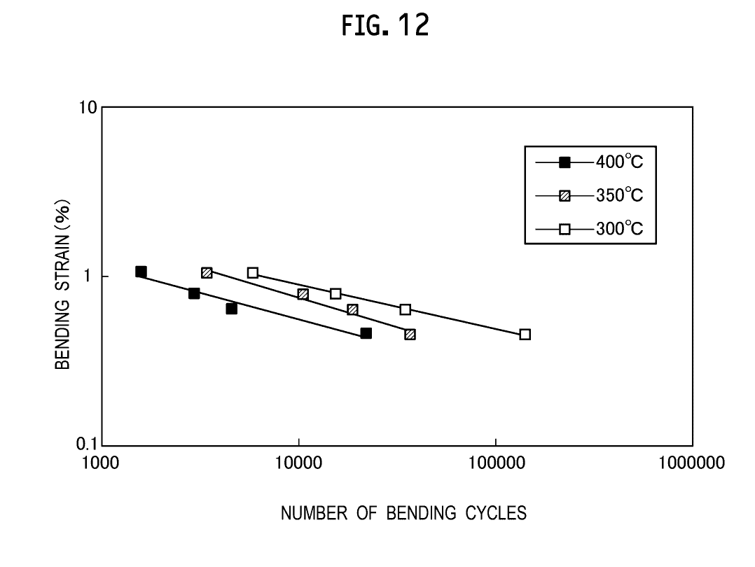

FIG. 12 and Table 3 illustrates the relationship between the bending strain and the number of bending cycles of the test pieces obtained after final heat treatment at 300, 350, and 400° C. in Example 1. FIG. 12 reveals that when the bending strain is not more than 1%, the test pieces obtained after final heat treatment at 300 and 350° C., which include the large and small grain domains 2 and 3, show large numbers of bending cycles and are excellent in flexibility. Since the cross-sectional areas of these test pieces satisfy the relationship of Formula 2, it is confirmed that satisfying the relationship increases the flexibility.

TABLE 3

| Final Heat | |
|---|---|
| Treatment | |
| Temperature | Bending Strain (%) |

| (° C.) | 1.06 | 0.79 | 0.64 | 0.46 |
|---|---|---|---|---|
| 300 | 5798 | 15280 | 34440 | 176610 |
| 350 | 3398 | 10515 | 18615 | 34748 |
| 400 | 1590 | 2948 | 4583 | 21833 |

Table 4 illustrates the relationship between the bending strain and the number of bending cycles of test pieces obtained after a final heat treatment at 300° C. of Example 2. Table 4 reveals that when the bending strain is not more than 1%, the number of bending cycles is high, and the test pieces have excellent flexibility.

TABLE 4

| | |
|---|---|
| Final Heat | |
| Treatment | |
| Temperature | Bending Strain (%) |

| (° C.) | 1.06 | 0.79 | 0.64 | 0.46 |
|---|---|---|---|---|
| 300 | 3618 | 11873 | 25935 | 61900 |

### (Measurement of Tensile Strength and 0.2% Proof Stress)

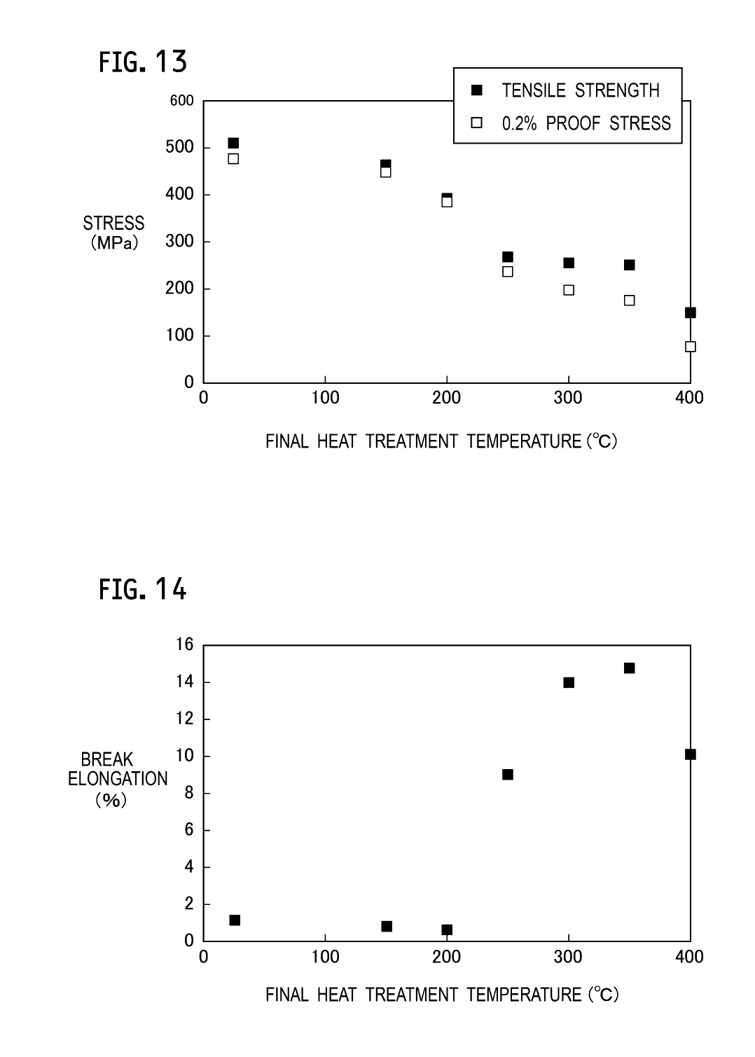

The tensile strength and 0.2% proof stress of test pieces obtained after final heat treatment at 150, 200, 250, 300, 350, and 400° C. in Example 1 are measured according to JIS Z2241. The measurement results are illustrated in FIG. 13 and Table 1. The tensile strength and 0.2% proof stress of aluminum wires not subjected to the final heat treatment in Example 1 are measured in a similar manner, and the results thereof are illustrated in FIG. 13 and Table 1. As illustrated in FIG. 13, as the final heat treatment temperature increases, the tensile strength and 0.2% proof stress tend to be reduced. However, it is revealed that high strength is maintained when the aluminum wire includes both the large and small grain domains.

The tensile strength and 0.2% proof stress of test pieces obtained after a final heat treatment at 300° C. in Example 2 are measured according to JIS Z2241. The measurement results are illustrated in Table 2. Table 2 reveals that high strength can be also maintained in Example 2.

### (Measurement of Break Elongation)

The break elongation of test pieces obtained after final heat treatment at 150, 200, 250, 300, 350, and 400° C. in Example 1 are measured according to JIS Z2241. The measurement results are illustrated in FIG. 14 and Table 1. The break elongation of aluminum wires not subjected to the final heat treatment in Example 1 is measured in a similar manner, and the results thereof are illustrated in FIG. 14 and Table 1. As illustrated in FIG. 14, the break elongation tends to increase as the final heat treatment temperature increases. The break elongation (elongation percentage) of the test pieces obtained after final heat treatment at 250, 300, 350, and 400° C. is not less than 7%. These results reveal that as the ratio of large grain domain increases, the elongation percentage increases, and the flexibility increases.

The break elongation of test pieces obtained after a final heat treatment at 300° C. in Example 2 is measured according to JIS Z2241. The results thereof are illustrated in Table 2. Table 2 reveals that the break elongation (elongation percentage) is not less than 7% also in Example 2.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

1. An aluminum electrical wire, comprising:
an aluminum wire, wherein
in the radial cross section of the aluminum wire vertical to the longitudinal cross section thereof, the average grain size of metal micro structure of the aluminum wire at the center is larger than the average grain size of metal micro structure in the periphery.

2. The aluminum electrical wire according to claim 1, wherein
the aluminum wire includes a large grain domain and a small grain domain,
in the radial cross section of the aluminum wire vertical to the longitudinal cross section thereof, the large grain domain is located at the center while the small grain domain is located around the large grain domain, and
the average grain size of metal micro structure constituting the large grain domain is larger than the average grain size of metal micro structure constituting the small grain domain.

3. The aluminum electrical wire according to claim 2, wherein
in the radial cross section of the aluminum wire vertical to the longitudinal cross section thereof, the radial cross-sectional area (Aₛₘₐₗₗ) of the small grain domain with respect to the total (Aₜₒₜₐₗ) of the radial cross-sectional area (A_{large}) of the large grain domain and the radial cross-sectional area (Aₛₘₐₗₗ) of the small grain domain satisfies the following relationship:
0.10≦Aₛₘₐₗₗ/A_{large}≦0.99

4. The aluminum electrical wire according to claim 1, wherein crystal grains of the metal micro structure constituting the periphery of the aluminum wire have predominantly (111), (211), and (311) textures parallel to the radial cross section of the aluminum wire vertical to the longitudinal cross section thereof.

5. The aluminum electrical wire according to claim 2, wherein in crystal grains of the metal micro structure constituting the small grain domain have predominantly (111), (211), and (311) textures parallel to the radial cross section of the aluminum wire vertical to the longitudinal cross section thereof.

6. A wire harness, comprising
an aluminum electrical wire according to claim 1.
